(19) United States
(12) Patent Application Publication
(10) Pub. No.: US 2009/0319182 A1
(43) Pub. Date: Dec. 24, 2009

(54) USER POSITIONING GUIDANCE SYSTEM, DEVICES, AND METHODS

(76) Inventor: Dante Monteverde, Barrington Hills, IL (US)

Correspondence Address: SEYFARTH SHAW LLP, 131 S. DEARBORN ST., SUITE 2400, CHICAGO, IL, 60603-5803, US

(21) Appl. No.: 12/141,883

(22) Filed: Jun. 18, 2008

(51) Int. Cl. G06G 7/78; G06F 17/30

(52) U.S. Cl. 701/209; 455/456.3; 701/211; 455/41.1

(57) ABSTRACT

Systems, devices, and methods for providing guidance to a user or visitor to an environment to enable the visitor to visit a plurality of locations based on a predetermined list of items are disclosed, the list being determined based on, for instance, items to be purchased from one or more stores, booths at a convention to be visited, or gallery displays at a museum to be viewed. Disclosed is a device carried on or by the visitor that is recognized by a location system stationed at the environment for determining where the visitor is, and a system such as a network at the environment for correlating the location of the visitor and the list to provide routing information to the visitor, such as by presenting the routing information on the device carried by the user or on displays located in the environment.

### CROSS-REFERENCE TO RELATED APPLICATION(S)

The present application is related to co-pending application Ser. No. 12/141,880, filed Jun. 18, 2008 and titled “Methods and Systems for Expositions and Conventions,” the entirety of which is incorporated herein by reference.

### FIELD OF THE INVENTION

The invention relates to guidance and navigation for persons within an environment and, in particular, to systems and devices and methods for providing a person with information regarding and for routing and navigating within an environment to arrive at one or more locations or destinations.

### BACKGROUND

It is not uncommon for people to have no particular set order for achieving a plurality of tasks where each of the tasks is to be completed at locations separated by distances. As an example, many people do not bother to plan an order for a variety of errands that need to be run using their automobile unless one is dependent on the other, such as getting cash from a bank before going to a movie theater. More commonly, people get in their vehicles and criss-cross around town in a haphazard and inefficient manner. In some cases, a comprehensive list of locations that need to be visited is not even compiled, rather the list being augmented by whim and condensed by a lack of time.

It is known to rely on technology to provide assist users. For instance, Japanese Laid-Open Application No. 2005/025639 describes a system allowing a user, prior to attendance at a convention or exhibition, to pre-select the booths that are desired to be visited. The system then provides a route for circulating or visiting each of the selected booths, the route being displayed on to the user. Japanese Laid-Open Application No. 2005/063194 describes a system that delivers information to a user's portable terminal while the user visits an exhibition hall. Japanese Laid-Open Application No. 01/300507 describes a guides system that calculates the shortest route from a present location to a destination location.

It is also known to rely on technology to provide information to a user about a current location. For instance, it is known to provide users with a hand-held device for navigating museums so that, upon reaching a particular display or exhibition or piece of artwork, the device recognizes the position of the user and provides information regarding that which is at the position of the user. Such a system has also been adapted for use at convention centers, for instance, as is described in published PCT application no. WO 2007/063571.

However, all technology has suffered from a number of deficiencies. For instance, the prior art systems do not permit dynamic updating of the supplied route for when the user adds a destination. Specifically, a user at a convention hall or a museum utilizing a route provided by the systems of the prior art may hear about another booth or gallery display that the user had not already selected but would like to visit. The prior art systems do not allow the user to input this additional booth or display and immediately re-map the route for the user. At best, the user may find the display or booth on their own, and the system may recognize the deviation and provide instructions for returning to the pre-determined route.

A further problem is the ability of a user to know exactly to what the system is referring when the user has reached a particular location. As an example, a museum guide device may play an audio track to a user upon reaching a particular location. However, it is not uncommon for several objects to be located in close proximity, and the user often will struggle to determine which of the objects is the subject of the audio track. It can be imagined that, in some locations such as a retail establishment, many objects are located close to each other and it may be difficult to discern why the user was brought to a particular location; in such a case, the user must rely on their own memory (or a shopping list) and determine which item seems appropriate.

Accordingly, there has been a need for improved systems, methods, and devices for assisting users in navigating an environment through a plurality of locations.

### SUMMARY

In accordance with an aspect, a system for enabling a visitor to an environment to navigate to a plurality of locations within the environment is disclosed, the system including a user positioning device carried by the visitor, a stationary location system including at least one stationary location device located in the environment, the user positioning device and the at least one stationary location device able to communicate to determine a position of the visitor, and at least one display for presenting information to the user, the information including routing information.

In some forms, the system includes an input device for the visitor to input a list, wherein the routing information includes routing information of locations for each of the list items. The system may further include a network, wherein the network includes the stationary location system and a plurality of displays, the displays distributed in the environment and presenting routing information to the visitor based on the locations for the list items that have been visited and have not been visited. The input device may communicate with the network via the Internet. The user positioning device may include the input device. The user positioning device may include the display.

In another aspect, a method for enabling navigation of an environment by a visitor to a plurality of locations within the environment based on a predetermined list is disclosed, the method including providing the predetermined list, the list including a plurality of items, correlating the items to item locations, providing a user positioning device to the visitor, communicating between the user positioning device and stationary location system to determine a visitor location within the environment, providing routing information to the visitor to direct the visitor to item locations, the routing information based on item locations that have been visited and have not been visited.

In some forms, the step of providing the predetermined list includes the visitor inputting the list to an input device. The method may include the step of providing a network, wherein the step of providing the predetermined list includes transmitting the list from the input device to the network. The step of providing a network may include providing a plurality of displays, and the step of providing routing information to the visitor may include presenting information on the displays to the visitor.

In some forms, the method includes providing item information to the visitor.

In some forms, the step of providing item information includes presenting a non-text visual representation of the item.

In some forms, the item is one of a booth of an exhibitor at a convention hall, a grocery store item, and a point-of-interest.

In some forms, at least some of the list items are network-supplied items. The network-supplied items may include suggestions based on user-input items. The network-supplied items may include suggestions based on user-input queries. The network-supplied items may be based on user-input parameters.

In accordance with another aspect, a system for providing user positioning guidance is disclosed, the system comprising a network, a plurality of stationary location devices, a user-carried positioning guidance device, the stationary location devices recognizing the presence or proximity of the positioning guidance device to determine a location of the user, and at least one display, wherein the network communicates with the stationary location devices to receive a location of the user, the network includes a predetermined list of items correlated to locations, and the network transmits routing information to the display for presentation thereon to the user.

In some forms, the at least one display includes a plurality of displays distributed in an environment, and the plurality of stationary location devices are distributed in the environment.

In some forms, the positioning guidance device includes the at least one display.

### BRIEF DESCRIPTION OF THE DRAWINGS

FIG. 1 is a representational view of an environment in which a plurality of items having locations are distributed, the environment having a network including location devices or sensors and a including displays for presenting information to a visitor, the visitor shown having a guidance device for navigating the environment to reach locations therein correlating to a list of items;

FIG. 2 is a representational view of an input device in the form of a personal computer for inputting the list to the network; and

FIG. 3 is a representational view of an alternative environment into which a plurality of items may be brought, the alternative environment including a network for directing the locations to which the items are to be stored.

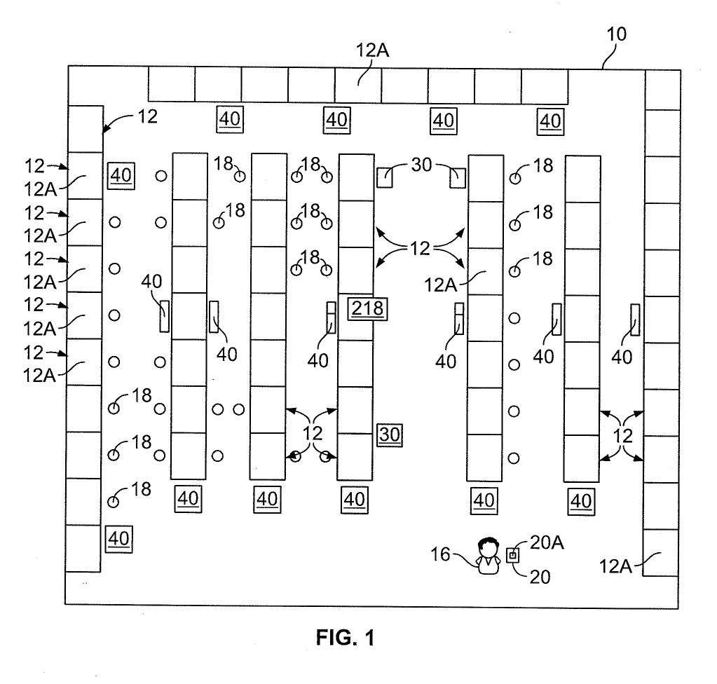

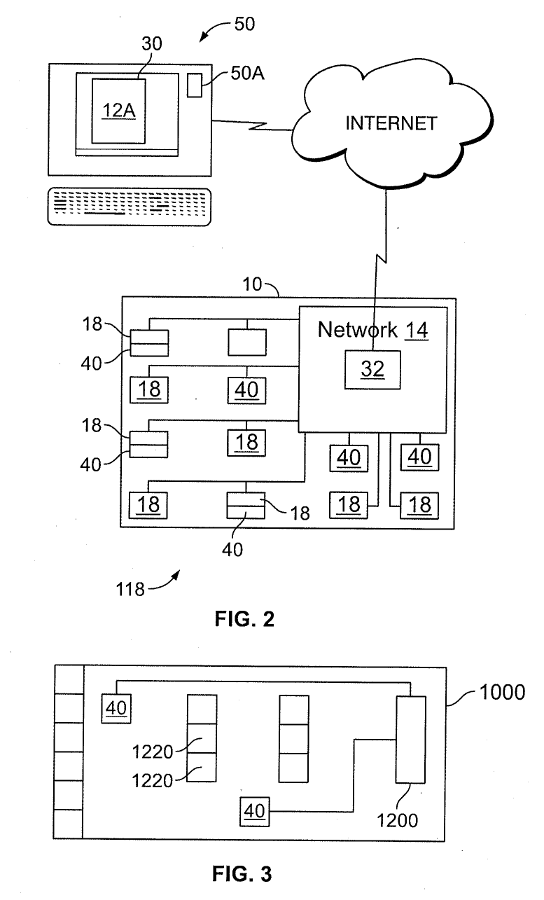

### DETAILED DESCRIPTION

In accordance with aspects of the invention, systems and methods and devices for providing dynamic navigation and direction to a user within an environment are disclosed. A user may provide a predetermined ‘shopping list’ which may be a list of booths to visit at a convention hall, may be a list of gallery displays at an art museum, or may be a literal shopping list of items to be purchased at a grocery store. The user is provided with information to guide the user through the environment based on the shopping list. Additionally, the user is permitted to dynamically update the shopping list, and the shopping list may augment itself by recognizing other suggested needs for the user, such as knowing that user always purchases milk but neglected to add milk to the shopping list. In a preferred form, a plurality of visual displays are distributed within the environment for communicating at least visual information, including navigation or location information, to users within the environment.

Referring to the Figures, a representative environment 10 is depicted having a plurality of locations 12 at which items 12a are located. In simple terms, the environment 10 recognizes the presence and location of a specific visitor 16 who has previously provided a list 30 of items 12a (such as a shopping list or a list of booths to be visited at a convention hall). Towards this end, the environment 10 is outfitted with a network 14 including a plurality of stationary location devices (SLD) 18, and the visitor 16 carries a portable user position guidance device (UPG) 20 which communicates with the SLDs 18.

There are two basic modes which may be utilized. In a first mode, the UPG 20 is for nothing other than identifying the presence or proximity of the visitor 16 to one or more SLDs 18, while in the second mode the UPG 20 is the principal manner in which the visitor 16 receives information. In either mode, the UPG 20 may include a radio-frequency identification (RFID) 20a so that the SLDs 18 recognize the UPG 20 as being in close proximity. The RFID 20a may be a powered RFID so that the broadcast/receptivity range is increased, in the order of 10-12 feet from the SLDs 18. In the first mode, the UPG 20 need not be anything more than a RFID 20a or the like so that the UPG 20 itself may be in the form of a nametag (such as at a convention hall) affixed to the visitor's person, or may be a small device that may be carried in the pocket of the visitor. In the second mode, the UPG 20 may be much more, such as a hand-held ‘smart’ or ‘dumb’ device, having ‘thin’ or ‘fat’ client architecture, and may include cellular telephony and/or Internet access capabilities.

The UPG 20 is recognized by the SLDs 18 which communicate the presence or proximity of the visitor 16 to a central computer 32 of the network 14. The network 14 identifies the specific visitor 16 and correlates the list 30 to the visitor 16. The environment 10 is equipped with a plurality of displays 40, such as television monitors which are preferably high-definition television sets with or without television tuners, and the displays 40 are part of the network 14. Based on the known location of the visitor 16, the network 14 directs one or more of the displays 40 to present information tailored to the visitor 16 to direct the visitor 16 from location to location within the environment 10. For instance, the network 14 may recognize the visitor 16 is leaving a particular booth at a convention center because the visitor's UPG 20 passes an SLD 18, and the network 14 directs a display 40 close to the particular booth to a) identify the user from the crowd (such as by presenting the visitor's name or a predetermined pseudonym) and b) provide directions to the next stop on a predetermined route through the convention center. In another form, the network 14 may recognize the visitor 16 is leaving the dairy section of a grocery store, and may direct the display 40 to, again, identify the user and to provide directions to the baking goods area of the grocery store, also based on the predetermined shopping list provided by the visitor 16. In some forms, the displays 40 and SLDs 18 may be co-located, in some forms they may be separately located, or, as shown in the Figs., there may be a combination.

It should be noted that the basic difference between the above-described first and second modes is that, in the second mode, the UPG 20 itself may also support and provide some of the functions (such as annotations regarding a particular location or an item from a shopping list) and or processing needs of the visitor 16. As an example, a visitor 16 reaching a dairy section of a grocery store environment 10 may not remember what item they intended to purchase, or may fail to recall all of the items that are to be purchased: both or either of the display 40 or the UPG 20 may present a visual indication of “milk,” “cottage cheese,” and “half-and-half,” to the visitor 16, and also may include a non-text visual representation of the item, such as a picture of the item so that the visitor 16 is assured of purchasing the desired quantity and/or brand of item, or a picture of a convention exhibitor's booth or graphic logo.

It is believed evident to one skilled in the art how the functions and processing may be allocated between the UPG 20 and the network 14, for instance. One advantage of the second mode is that a visitor 16 may decide to add to the list 30 via input to the UPG 20; for instance, the visitor 16 to a grocery store environment 10 may realize that a bottle of wine would be nice, input such to the UPG 20, and the UPG 20 and network 14 can work together to update the routing information for the visitor 16 so that this addition is incorporated. In contrast, the first mode (as well as the second mode) permits a visitor 16 to input additional queries or add to the list 30 by, for instance, approaching a display 40 or other device which, by virtue of a proximate SLD 18, recognizes the visitor 16, and speaking in or typing in the further query or list addition. It should be noted that both or either of the UPG 20 and the displays 40 may provide a combination of alerts or information to the user, including but not limited to audio alerts or vibrational alerts.

It should be noted that the network 14 includes an SLD system 118 comprising the plurality of SLDs 18. While the SLDs 18 may be simple RFID-type receivers, such that the only item of information that may be determined is an RFID passing by the SLD 18, they may alternatively be much more sophisticated. To detail, the SLDs 18 may be distributed throughout the environment 10 or may be provided as a single, master SLD receiver beacon 218. For the latter, it is known to determine a location of an object based on signal strength and polar direction from the beacon 218, though this requires a relative strong signal and computer processing power to determine the direction and position. In the former, the SLDs 18 may be operating in a multiplexed manner and operating on triangulation principles within the environment 10 so that the exact position of the visitor 16 with the UPG 20 is known at all times. For instance, the environment 10 may include three or more positioning SLDs 18 strategically placed throughout the environment 10 for determining the position of each visitor 16. As such, the UPGs 20 are broadcasting-type devices for transmitting a signal to the SLDs 18, or for two-way communication with the SLD system 118. In this manner, the UPG 20 may be provided with information to be displayed thereon, and the network 14 may direct the displays 40 to provide information appropriate to visitors 16.

The navigational and routing may be based on one or more approaches including learned (historical) behavior, directed behavior, or unique behavior. To be specific, learned or historical behavior is when the network 14 records the route taken by people (such as visitors 16 to a museum environment 10) and bases a route provided to a visitor 16 on such historical behavior. Directed behavior refers to when an environment 10, such as a museum, provides a pre-determined and somewhat scripted route for a visitor 16 to follow, though the visitor 16 may deviate and the network 14 would then dynamically adjust to accommodate the deviation. Unique behavior refers to when a specific visitor 16 prepares a specific request for routing information based upon the list 30 for a specific visit to the environment 10.

In greater detail, the unique behavior approach is the dominant focus of aspects of the present invention. Towards this end, the visitor 16 pre-selects the list 30. While the list may be inputted directly to the network 14 located at or in the environment 10, it is preferred that the list 30 is input in another manner, i.e., remotely. The list 30 is input to an input device 50 which may be hand-held device, or into a computer, or anything else that includes a storage medium 50a. The input device 50 may be connected with the network 14, or the storage medium 50a (such as a memory card) may be removed from the input device 50 and connected to the network 14 for uploading the list 30. In a preferred form, the visitor 16 inputs the list 30 to an input device 50 in the form of a personal computer, and the list 30 is transmitted to the network 14 via the Internet.

It should be noted that a graphical interface (i.e., web interface) with the network 14 presented on the personal computer input device 50 may include default items for the list 30: for instance, the visitor 16 may selected cat food and milk every week, and soda every other week, and the list 30 may be auto or pre-populated based on historical lists 30; in another form, the network 14 may auto-populate the list 30 with popular gallery displays for a museum environment 10; in other forms, the environment 10 may receive advertising money for displaying products or auto-populating the list 30 with suggested products.

It should be recognized that the visitor 16 may not, personally, know all the information that is necessary. More specifically, a person shopping for themselves may known the desired size of milk to purchase, and likely knows their own clothing size. However, the list 30 may be prepared based on another person's needs or instructions. For instance, one person in a household may desire a particular flavor of cereal and this information is then input to the list 30: another person entirely may be the visitor 16 that enters the environment 10 in order to purchase the items on the list 30. The input device 50, the UPG 20, the network 14, or a combination may store information as to different persons' preferences or desires, such as clothing sizes. This enables the systems herein to utilize logic based on generalized parameters: in a specific example, a visitor 16 may input information particular to them, and the network 14 can present a route based on this particular information.

In greater detail for the logic aspect, a number of examples are given. A visitor 16 to a museum environment 10 may input their age: a ten-year-old visitor is likely to appreciate a particular museum display in a different manner than a sixty-year-old visitor; the network 14 may provide routing information that is different based on this age, and may provide information on the displays 40 or on the UPG 20 that is tailored to the specific visitor audience, such as by avoiding use of vocabulary words not likely to be known to a younger visitor, avoiding of discussing scandalous material that may not be appropriate for a younger visitor, or not assuming common knowledge for the younger visitor (such as Vincent van Gogh's removal of his ear).

As another example, the visitor 16 may input that a restricted sodium diet is desired, and the network 14 may be able to highlight that certain items on the list 30 are high in sodium, and/or provide suggestions for alternative choices to reduce sodium.

In some forms, the network 14 may be able to communicate with, for instance, a so-called intelligent refrigerator which has itself identified the need for milk, and the network 14 may alert the oversight by the input list 30 to the visitor 16.

The network 14 may also have predictive capabilities, such as noting that a list 30 includes pizza sauce and pizza crust but has omitted cheese, or by noting that a list 30 includes all but one booth at a convention that sells a particular type of product or service, such omissions being brought to the attention of the visitor 16. In one such form, the network 14 may support a request at the conclusion of a visit to the environment 10, yet prior to leaving, the request being of a ‘is there anything I missed?’ nature, and the network 14 can analyze the locations visited by the visitor 16 and provide suggestions based on either logical relationships or historical tendencies of the specific visitor 16 or other visitors.

The language or tongue of the visitor 16 can be input so that all communication can be translated/tailored to the visitor 16.

In some forms, the items in the environment 10, such as a grocery store or retail store, may be provided with individual RFID tags so that the UPG 20 and/or SLD 18 and network 14 may recognize that the proper product has been selected and retrieved.

In some forms, a second or alternative environment 1000 is contemplated, the alternative environment 1000 being a place where an item from the list 30 may be used or stored. For instance, once the list 30 of items has been purchased at the store environment 110, the items are transported to the alternative environment 1000. Upon entering the alternative environment 1000, an alternative stationary location system 1200 recognizes the presence of the items, and the UPG 20 or a display 40 located in the alternative environment 1000, or both, can be provided with an indication of proper location 1220 for the items to be stored (such as, top shelf of refrigerator, bottom shelf of rack in garage, etc.). The UPG 20 can store additional information regarding the items such as frequency of need to assist in understanding the use of the items.

The systems and methods and device described herein may be used in environments 10 other than those described herein. For instance, a visitor 16 to a golf course may not know how to get from a green of one hole to the tee boxes of a subsequent hole, may require direction to a restroom or refreshment stand (or may want an alert when a refreshment cart is being driven in close proximity so that the golfer can alert the driver of a desire to purchase something), and may need immediate directions to the clubhouse due to a sudden lightning storm. A visitor 16 who is a tourist, either driving a vehicle or a pedestrian, may desire routing information to particular points of interest or simply to return to a hotel. The dynamic and logic aspects of the invention enable such information to be presented to such users, either on the UPG 20 or on displays 40 distributed in a golf course environment 10 or on a roadway environment 10.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A system for enabling a visitor to an environment to navigate to a plurality of locations within the environment, the system including:
a user positioning device carried by the visitor;
a stationary location system including at least one stationary location device located in the environment, the user positioning device and the at least one stationary location device able to communicate to determine a position of the visitor; and
at least one display for presenting information to the user, the information including routing information.

2. The system of claim 1 further including an input device for the visitor to input a list, wherein the routing information includes routing information of locations for each of the list items.

3. The system of claim 2 further including a network, wherein the network includes the stationary location system and a plurality of displays, the displays distributed in the environment and presenting routing information to the visitor based on the locations for the list items that have been visited and have not been visited.

4. The system of claim 3 wherein the input device communicates with the network via the Internet.

5. The system of claim 3 wherein the user positioning device includes the input device.

6. The system of claim 3 wherein the user positioning device includes the display.

7. A method for enabling navigation of an environment by a visitor to a plurality of locations within the environment based on a predetermined list, the method including:
providing the predetermined list, the list including a plurality of items;
correlating the items to item locations;
providing a user positioning device to the visitor;
communicating between the user positioning device and stationary location system to determine a visitor location within the environment; and
providing routing information to the visitor to direct the visitor to item locations, the routing information based on item locations that have been visited and have not been visited.

8. The method of claim 7 wherein the step of providing the predetermined list includes the visitor inputting the list to an input device.

9. The method of claim 8 further including the step of providing a network, wherein the step of providing the predetermined list includes transmitting the list from the input device to the network.

10. The method of claim 9 wherein the step of providing a network includes providing a plurality of displays, and the step of providing routing information to the visitor includes presenting information on the displays to the visitor.

11. The method of claim 7 further including providing item information to the visitor.

12. The method of claim 7 wherein the step of providing item information includes presenting a non-text visual representation of the item.

13. The method of claim 7 wherein the item is one of a booth of an exhibitor at a convention hall, a grocery store item, and a point-of-interest.

14. The method of claim 7 wherein at least some of the list items are network-supplied items.

15. The method of claim 14 wherein the network-supplied items include suggestions based on user-input items.

16. The method of claim 14 wherein the network-supplied items include suggestions based on user-input queries.

17. The method of claim 14 wherein the network-supplied items are based on user-input parameters.

18. A system for providing user positioning guidance, the system comprising:
a network;
a plurality of stationary location devices;
a user-carried positioning guidance device, the stationary location devices recognizing the presence or proximity of the positioning guidance device to determine a location of the user;
and at least one display, wherein the network communicates with the stationary location devices to receive a location of the user, the network includes a predetermined list of items correlated to locations, and the network transmits routing information to the display for presentation thereon to the user.

19. The system of claim 18 wherein the at least one display includes a plurality of displays distributed in an environment, and the plurality of stationary location devices are distributed in the environment.

20. The system of claim 18 wherein the positioning guidance device includes the at least one display.
